(19) United States
(12) Patent Application Publication
(10) Pub. No.: US 2026/0321596 A1
(43) Pub. Date: Oct. 15, 2026

(54) COMPOSITE NEGATIVE ELECTRODE, PREPARATION METHOD THEREFOR, AND BATTERY

(71) Applicant: MICROVAST, INC, Stafford, TX (US)

(72) Inventors: Haojun QI, Stafford, TX (US); Daohui LI, Stafford, TX (US); Weifeng FANG, Stafford, TX (US); Wenjuan Liu MATTIS, Stafford, TX (US)

(73) Assignee: MICROVAST, INC, Stafford, TX (US)

(21) Appl. No.: 19/175,687

(22) Filed: Apr. 10, 2025

(51) Int. Cl. H01M 4/36; H01M 4/02; H01M 4/04; H01M 4/133; H01M 4/134; H01M 4/38; H01M 4/583; H01M 4/62; H01M 4/66; H01M 4/75

(52) U.S. Cl. CPC H01M 4/366; H01M 4/0471; H01M 4/133; H01M 4/134; H01M 4/382; H01M 4/386; H01M 4/583; H01M 4/622; H01M 4/625; H01M 4/661; H01M 4/75; H01M 2004/021; H01M 2004/027

(57) ABSTRACT

A composite negative electrode, a preparation method therefor, and a battery are provided. The method includes: providing a first material on a first substrate to form a first material layer; and providing a second material on a second substrate to form a second material layer, bonding the second material layer to the first material layer, performing hot pressing on the first material layer and the second material layer, and then removing the second substrate to obtain the composite negative electrode, at least part of the composite negative electrode having a concentration gradient in the thickness direction thereof; or directly providing the second material on the first material layer to form a second material layer, and performing hot pressing on the first material layer and the second material layer to obtain a composite negative electrode, some of the composite negative electrode having a concentration gradient in the thickness direction thereof.

### TECHNICAL FIELD

The present invention relates to the field of lithium metal batteries, and in particular, to a composite negative electrode, a preparation method therefor, and a battery. More particularly, the present invention relates to a composite negative electrode for preparing a lithium metal battery, a method for preparing the composite negative electrode, and a lithium metal battery comprising the composite negative electrode.

### BACKGROUND

A lithium metal negative electrode, due to having a large theoretical specific capacity and a low electrochemical potential, is an extremely promising negative electrode material of a high energy density battery; however, lithium dendrites will occur in a lithium metal battery during the charging and discharging cycle, resulting in a short circuit.

In order to solve this problem, a lithium alloy is generally used to prevent the occurrence of lithium dendrites. However, a dead lithium phenomenon easily occurs in currently used lithium alloy negative electrode materials, which causes an interface reaction, and thus reduces the battery capacity. How to solve lithium dendrites and dead lithium phenomenon of a lithium metal battery during the charging and discharging cycle and ensure the capacity and cycle performance of a cell has become an urgent problem to be solved in the art.

### SUMMARY

The main object of the present invention is to provide a method for preparing a composite negative electrode and a composite electrode prepared by the method, so as to solve the problems of lithium dendrites and dead lithium in lithium metal batteries in the prior art during the charging and discharging cycle.

In order to achieve the described object, one aspect of the present invention provides a method for preparing a composite negative electrode. The method comprises the following steps: step S1, providing a first material on a first substrate to form a first material layer; and step S2, providing a second material on a second substrate to form a second material layer, bonding the second material layer to the first material layer, performing hot pressing on the first material layer and the second material layer, and then removing the second substrate to obtain a composite negative electrode, wherein at least part of the composite negative electrode has a concentration gradient in the thickness direction, or directly providing the second material on the first material layer to form the second material layer, and performing hot pressing on the first material layer and the second material layer to obtain a composite negative electrode, wherein at least part of the composite negative electrode has a concentration gradient in the thickness direction thereof.

Further, in step S1, the first material comprises a lithium-containing material, and the first substrate is selected from a copper foil and a composite copper foil.

Further, in step S2, the second material comprises a carbon material and/or a silicon material, and the second substrate is selected from a copper foil and a composite copper foil.

Further, the carbon material comprises one or more of natural graphite, artificial graphite, soft carbon, hard carbon, carbon black, ketjen carbon, acetylene black, Super P, grapheme, and single-walled carbon nanotubes, and the silicon material comprises one or more of monocrystalline silicon, polycrystalline silicon, and amorphous silicon.

Further, the thickness of the first material layer is in the range of 5 μm to 30 μm, and/or the thickness of the second material layer is in the range of 10 μm to 60 μm.

Further, in step S2, the average particle size (D50) of the second material is in the range of 1 μm to 40 μm.

Further, in step S2, the second material layer further comprises an adhesive, and the adhesive comprises one or more of polyacrylic acid (PAA), styrene-butadiene rubber (SBR), polyvinylidene fluoride (PVDF), and carboxymethyl cellulose (CMC).

Further, in step S2, the second material layer further comprises a conductive agent, and the conductive agent comprises a vapor grown carbon fiber (VGCF).

Further, the second material comprises silicon, graphite, and carbon nanotubes, and the mass ratio of the silicon to the graphite is 0.1-5.0, and the mass ratio of the silicon to the carbon nanotubes is 0.5-20.0.

Further, the ratio of a thickness H₁ of the second material layer to a thickness H₂ of the first material layer satisfies 1<H₁/H₂≤10.

Further, the ratio of an area S₁ of the second material layer to an area S₂ of the first material layer satisfies 1.0<S₁/S₂≤1.5.

Further, in step S2, the hot pressing is performed at a pressure of 10 MPa to 40 MPa at a temperature of 60° C. to 100° C.

Further, in step S2, the duration of the hot pressing lasts for 5 min to 30 min.

Further, in step S1, a copper-lithium composite current collector is used as a composite of a first substrate and a first material layer, and in step S2, a second material is directly provided on a lithium layer of the composite to form a second material layer.

Further, in step S2, the concentration gradient is a concentration gradient of the first material; or a concentration gradient of both the first material and the second material.

Another aspect of the present invention further provides a composite negative electrode prepared by the described method, wherein the composite negative electrode comprises a substrate and a negative electrode coating layer provided on the substrate, the negative electrode coating layer comprises a lithium-containing material and a second material, the negative electrode coating layer has a concentration gradient of the lithium-containing material in the thickness direction, and the content of the lithium-containing material gradually decreases in partial thickness in a direction away from the substrate along the composite negative electrode.

Further, in partial thickness, the mass ratio of the lithium-containing material in the negative electrode coating layer varies with the coating layer thickness in the range of (1-5 wt %)/μm.

Further, in a direction away from the substrate along the composite negative electrode, the content of the second material gradually increases.

Further, the thickness of the negative electrode coating layer is d, and in the range of 2% d-25% d from the substrate, the mass of the lithium-containing material is 50%-70% of the total mass of the lithium-containing material in the negative electrode coating layer; in the range of 25% d-40% d from the substrate, the mass of the lithium-containing material is 20%-40% of the total mass of the lithium-containing material in the negative electrode coating layer; and in the range of 40%-90% d from the substrate, the mass of the lithium-containing material is 10%-20% of the total mass of the lithium-containing material in the negative electrode coating layer.

In order to achieve the described object, another aspect of the present invention provides a lithium metal battery. The lithium metal battery comprises: a positive electrode, an electrolyte, and a composite negative electrode prepared by the method of the present invention or the composite negative electrode of the present invention.

In the technical solution of the present invention, by providing a second material layer on a first material layer located on a first substrate, and hot pressing the bonded first material layer and second material layer, a composite negative electrode can be obtained, and at least a part of the composite negative electrode has a concentration gradient in the thickness direction thereof. The preparation method of the present invention is simple and easy to operate, thereby improving the production efficiency. The composite negative electrode prepared according to the method of the present invention can prevent lithium dendrites from growing in the electrolyte direction, and prevent lithium dendrites and dead lithium phenomena during the charging and discharging cycle of a lithium ion battery, thereby effectively reducing the interface impedance of a solid-state battery, and improving the cycle performance of a cell while improving the rate performance of the cell.

### BRIEF DESCRIPTION OF THE DRAWINGS

The accompanying drawings, which form a part of the present application, are used to provide a further understanding of the present invention. The schematic examples of the present invention and the description thereof are used to explain the present invention, and do not form improper limits to the present invention. In the drawings:

FIG. 1 is a schematic diagram showing a gradient structure of a composite negative electrode according to an embodiment of the present invention;

FIG. 2 shows a schematic diagram of a method for preparing a composite negative electrode according to an embodiment of the invention; and

FIG. 3 shows changes in the discharge specific capacity and the coulomb efficiency during the charging and discharging cycle according to example 3 of the present invention.

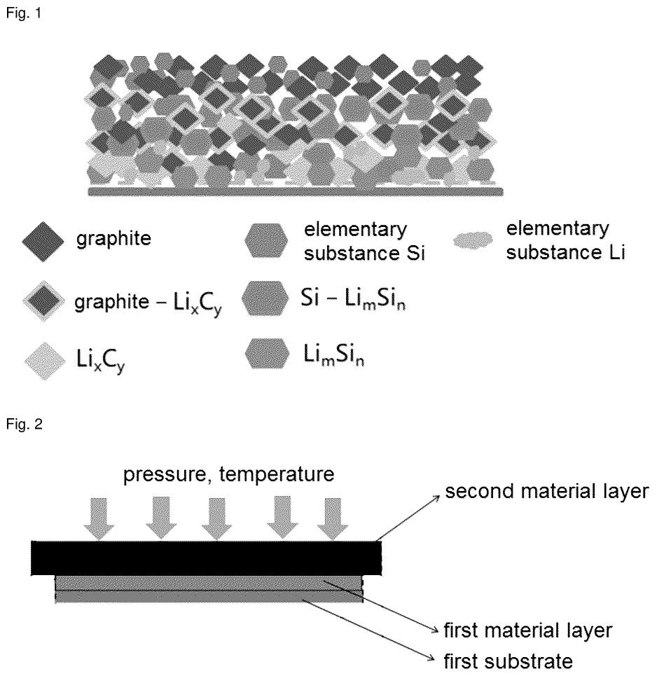

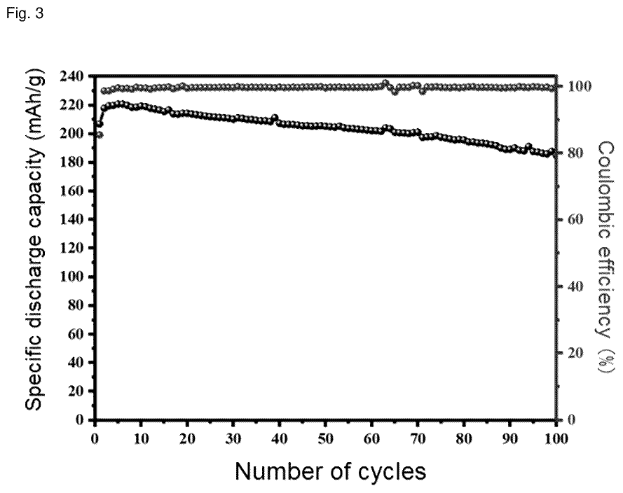

### DETAILED DESCRIPTION OF EMBODIMENTS

It should be noted that the features in the examples of the present application can be combined with each other without conflict. Hereinafter, the present invention will be described in detail with reference to examples.

As described in the background art, the existing lithium metal batteries have a problem of lithium dendrites and dead lithium during the charging and discharging cycle. In order to solve the described technical problem, an embodiment of the present application provides a method for preparing a composite negative electrode. The method comprises the following steps: step S1, providing a first material on a first substrate to form a first material layer; and step S2, providing a second material on a second substrate to form a second material layer, bonding the second material layer to the first material layer, performing hot pressing on the first material layer and the second material layer, and then removing the second substrate to obtain a composite negative electrode, wherein at least part of the composite negative electrode has a concentration gradient in the thickness direction, or directly providing the second material on the first material layer to form the second material layer, and performing hot pressing on the first material layer and the second material layer to obtain a composite negative electrode, wherein at least part of the composite negative electrode has a concentration gradient in the thickness direction thereof.

By further providing a second material layer on the first material layer on the first substrate, and performing a hot pressing treatment on the bonded first material layer and second material layer, a composite negative electrode can be obtained, and at least part of the composite negative electrode has a concentration gradient in the thickness direction thereof. The first material layer and the second material layer are bonded/combined and subjected to a hot pressing treatment, so that close contact between the materials and formation of a gradient structure can be achieved. The hot pressing treatment can promote a chemical reaction between the first material (lithium-containing material) and the second material (carbon and silicon material), so that at least part of the composite negative electrode forms a concentration gradient of the first material and/or the second material in the thickness direction. The gradient structure shows that the concentration of the first material (lithium-containing material) gradually decreases and the concentration of the second material (carbon and silicon material) gradually increases from the first substrate to the direction away from the first substrate. The composite negative electrode having such a concentration gradient structure can effectively prevent formation of lithium dendrites, suppress the dead lithium phenomenon, reduce interface impedance at the same time, and finally improve cycle performance and rate performance of a battery. In addition, the preparation method of the present invention is simple and easy to operate, thereby further improving the production efficiency.

Further, in step S1, the first material comprises a lithium-containing material, and the first substrate is selected from a copper foil (e.g., an electrolytic copper foil) and a composite copper foil. Preferably, the lithium-containing material comprises one or more of lithium metal and a lithium alloy, and the lithium alloy comprises one or more of a lithium-silicon alloy and a lithium-carbon alloy. The type of the first material is within the range of the present disclosure, and the lithium element can provide lithium ion storage capability of the battery, which may help improve the initial capacity, cycle performance and safety of the battery. The lithium-containing material is preferably a lithium-silicon alloy or a lithium-carbon alloy. The lithium-silicon alloy has a relatively high theoretical specific capacity and a relatively low electrochemical potential, can further increase the energy density of a battery, and can further control the expansion rate of the material, and reduce the risk of structural damage during charging and discharging. In addition, the lithium-carbon alloy can stabilize the surface structure of a lithium metal negative electrode, reduce a side reaction with an electrolyte, and improve the cycle efficiency of a battery, and can also improve lithium ion intercalation and deintercalation processes, and thus further enhance the rate performance of the battery.

The lithium-containing materials are commercially available. Commercially available lithium-containing materials are typically coated on PET films, and in the preparation of the first material layer, the lithium-containing material needs to be transferred onto a first substrate, such as a copper foil, and then the PET film is removed to form a lithium-containing material layer on the first substrate. If the provided lithium-containing material does not comprise the PET film, it may be directly coated on the first substrate (such as a copper foil).

Further, in step S2, the second material comprises a carbon material and/or a silicon material, and the second substrate is selected from a copper foil (such as an electrolytic copper foil) and a composite copper foil. The type of the second material is within the range of the present disclosure, and can not only provide an additional lithium ion storage medium, but also form a gradient structure by combining with the first material layer, thereby effectively inhibiting the growth of lithium dendrites and reducing the dead lithium phenomenon, and further improving the cycle performance and rate performance of a battery.

Further, the carbon material comprises one or more of natural graphite, synthetic graphite, soft carbon, hard carbon, carbon black, Ketjen carbon, acetylene black, Super P, grapheme, and single-walled carbon nanotubes, and the silicon material comprises one or more of monocrystalline silicon, polycrystalline silicon, and amorphous silicon. The type of the carbon material is within the range of the present disclosure, and can not only serve as a good storage medium for lithium ions, but also provide good conductivity and structural stability. The type of the silicon material is within the range of the present disclosure, and can serve as an advantageous negative electrode material of a high energy density battery to reduce expansion and contraction during lithiation/delithiation and reduce structural damage to an electrode and degradation of battery performance.

Further, the thickness of the first material layer is in the range of 5 μm to 30 μm, and/or the thickness of the second material layer is in the range of 10 μm to 60 μm. For example, the thickness of the first material layer is 5 μm, 6 μm, 7 μm, 8 μm, 9 μm, 10 μm, 12 μm, 15 μm, 18 μm, 20 μm, 22 μm, 25 μm, 28 μm, or 30 μm. For example, the thickness of the second material layer is 10 μm, 15 μm, 20 μm, 25 μm, 30 μm, 35 μm, 40 μm, 45 μm, 50 μm, 55 μm, or 60 μm. If the thickness of the first material layer is too small (below 5 μm), it may not provide sufficient storage of lithium ions, thereby limiting the capacity of the battery. On the contrary, if the thickness is too large, internal impedance of the battery is increased, thereby affecting the rate performance and charge-discharge efficiency of the battery. A thinner second material layer (less than 10 μm) may not effectively inhibit the growth of lithium dendrites, and may not provide enough buffer space to adapt to the volume change of the silicon material. An excessively thick second material layer may increase the thickness of a cell, reduce energy density, increase internal impedance of a battery, and affect the rate performance.

Further, in step S2, the average particle size (D50) of the second material is in the range of 1 μm to 40 μm. For example, the average particle size (D50) of the second material is 1 μm, 5 μm, 8 μm, 10 μm, 12 μm, 15 μm, 18 μm, 20 μm, 25 μm, 30 μm, 35 μm, or 40 μm. The average particle diameter (D50) of the second material is within the range of the present disclosure, and can provide a sufficient surface area and volume ratio, facilitate rapid intercalation and deintercalation of lithium ions, and further improve the rate performance of the battery. An average particle size (D50) of less than 1 μm may increase the manufacturing cost and operation difficulty of the material, while an average particle size (D50) of more than 40 μm may decrease the lithium ion diffusion rate of the electrode, affecting the cycle stability and rate performance of the battery.

Further, in step S2, the second material layer further comprises an adhesive, the adhesive comprises one or more of polyacrylic acid (PAA), styrene-butadiene rubber (SBR), polyvinylidene fluoride (PVDF), and carboxymethyl cellulose (CMC), and the mass ratio of the second material to the adhesive is 1.5-55.0. For example, the mass ratio of the second material to the adhesive is 1.5, 3.0, 10.0, 15.0, 20.0, 30.0, 40.0, 50.0, 55.0, etc. The type of the adhesive and the mass ratio thereof are within the ranges of the present disclosure, which can maximize the utilization rate of the active material while ensuring the structural stability of the second material layer, thereby further improving the overall performance of the battery. If the mass ratio is too low, internal impedance of the electrode may be increased, and utilization of the active material may be reduced, thereby affecting capacity and rate performance of the battery. If the mass ratio is too high, the bonding force between the second material layer and the substrate may be insufficient, and the electrode may easily fall off during charging and discharging, thereby affecting the cycling stability and safety of the battery.

Further, in step S2, the second material layer further comprises a conductive agent, and the conductive agent comprises a vapor grown carbon fiber (VGCF). By adding the conductive agent, such as VGCF, to the second material layer, not only the electronic and ionic conductivity of the second material layer can be improved, but also the structural stability and overall performance thereof can be enhanced.

Further, the second material comprises silicon, graphite, and carbon nanotubes, the mass ratio of the silicon to the graphite is 0.1-5.0, and the mass ratio of the silicon to the carbon nanotubes is 0.5-20.0. For example, the mass ratio of the silicon to the graphite is 0.1, 0.5, 1.0, 3.0, 5.0, etc. For example, the mass ratio of the silicon to the carbon nanotubes is 0.5, 1.0, 5.0, 10.0, 12.0, 15.0, 18.0, 20.0, etc. Regulating the mass ratio of the silicon to the graphite and the mass ratio of the silicon to the carbon nanotubes can inhibit volume expansion during charging and discharging and improve the mechanical strength and electronic conductivity of the second material layer, and can also effectively prevent the growth of lithium dendrites, reduce the direct contact between the electrolyte and lithium metal, and further ensure the stability and long cycle life of the cell under high-rate charging and discharging conditions.

Further, the ratio of a thickness H₁ of the second material layer to a thickness H₂ of the first material layer satisfies 1<H₁/H₂≤10. For example, H₁/H₂ is 1, 2, 3, 4, 5, 6, 7, 8, 9, 10, etc. The ratio of the thickness H₁ of the second material layer to the thickness H₂ of the first material layer is within the range of the present disclosure. The thickness of the second material layer (for example, a material comprising carbon and silicon) is larger than that of the first material layer, which can further increase the effective capacity of the negative electrode and the energy density of the battery, thereby improving the overall capacity of the battery.

Further, the ratio of an area S₁ of the second material layer to an area S₂ of the first material layer satisfies 1.0<S₁/S₂≤1.5. For example, S₁/S₂ is 1.0, 1.1, 1.2, 1.3, 1.4, 1.5, etc. When S₁/S₂ is within the range of the present disclosure, the area of the second material layer can be appropriately expanded, so that the uniform distribution and reaction of lithium ions during charging and discharging can be ensured, and the locally too high concentration and current density of the lithium ions are avoided, thereby further reducing the formation of lithium dendrites and the occurrence of dead lithium phenomena, and further improving the cycle stability and safety of the battery.

Further, in step S2, hot pressing is performed at a pressure of 10 MPa to 40 MPa at a temperature of 60° C. to 100° C.

For example, during hot pressing, the pressure selected is 10 MPa, 15 MPa, 20 MPa, 25 MPa, 30 MPa, 35 MPa, 40 MPa, etc. The pressure value during the hot pressing within the range of the present disclosure can effectively promote the close contact and bonding between the first material layer (the lithium-containing material layer) and the second material layer (the material comprising silicon, graphite, carbon nanotubes, etc.) to form a stable interface, and can also ensure that the material layer forms a gradient structure in the thickness direction, and can further prevent the internal structure of the material layer from being damaged due to an excessive pressure. In this way, lithium dendrite and dead lithium problems of the lithium metal battery during the charging and discharging cycle can be avoided, and the cycle stability and rate performance of the battery are further improved.

For example, the temperature selected for performing hot pressing is 60° C., 65° C., 70° C., 75° C., 80° C., 85° C., 90° C., 95° C., 100° C., etc. The temperature during the hot pressing within the range of the present disclosure can facilitate the diffusion and reaction inside the materials, facilitate the formation of a lithium-silicon alloy and a lithium-carbon alloy, and help to form a gradient structure, and can also improve the adhesiveness of the material layer and enhance the mechanical strength of the composite material. The temperature of the present invention can balance the thermal stability of the material with the reaction activity in the hot pressing process, and ensure that the formation of a gradient structure does not cause degradation of the performance of the material. In this way, lithium dendrite and dead lithium problems of the lithium metal battery during charging and discharging cycle can be avoided, and cycle stability and rate performance of the battery are further improved.

Further, in step S2, the duration of the hot pressing lasts for 5 min to 30 min. For example, the duration of the hot pressing lasts for 5 min, 6 min, 7 min, 8 min, 9 min, 10 min, 15 min, 20 min, 25, 30 min, etc. The duration of hot pressing within the range of the present disclosure can improve the bonding strength between material layers, form gradient structures, control the production costs, and finally further improve the battery performance.

Further, in step S1, a copper-lithium composite current collector is used as a composite of a first substrate and a first material layer, and in step S2, a second material is directly provided on a lithium layer of the composite to form a second material layer. By directly providing the second material on the lithium layer, direct contact and reaction between the second material layer and the first material layer (the lithium layer) can be ensured, and the formation of the gradient structure can be further promoted. In addition, during hot pressing, the close bonding between the second material layer and the lithium layer helps to form a concentration gradient between the material layers, so that a transition from a higher concentration of lithium metal to a higher concentration of the carbon material and the silicon material effectively inhibits the formation of lithium dendrites, and further improves the cycling performance and rate performance of the battery.

Further, in step S2, the concentration gradient is a concentration gradient of the first material; or a concentration gradient of both the first material and the second material. The formation of the concentration gradient of the first material or the concentration gradient of both the first material and the second material can provide an orderly path for the migration of lithium ions and reduce the disordered diffusion of lithium ions during charging and discharging, thereby reducing the interface impedance and improving the rate performance of the battery. In addition, increasing the content of the second material, such as carbon and silicon, helps to inhibit the growth of lithium dendrites and reduce dead lithium phenomena, thereby further improving the cycle performance and safety of the battery.

Another embodiment of the present application provides a composite negative electrode prepared by the described method, wherein the composite negative electrode comprises a substrate and a negative electrode coating layer provided on the substrate, the negative electrode coating layer comprises a lithium-containing material and a second material, the negative electrode coating layer has a concentration gradient of the lithium-containing material in the thickness direction, and the content of the lithium-containing material gradually decreases in partial thickness in a direction away from the substrate along the composite negative electrode.

The composite negative electrode comprises a substrate and a negative electrode coating layer provided on the substrate, wherein the negative electrode coating layer is composed of a lithium-containing material and a second material (such as silicon, graphite, and carbon nanotubes), and has a concentration gradient distribution in the thickness direction. In a direction away from the substrate along the composite negative electrode, the content of the lithium-containing material gradually decreases. The formation of this gradient structure benefits from the control of the composition of the material layer during preparation and hot pressing. The gradient distribution of the concentration of the lithium-containing material can effectively prevent the growth of lithium dendrites, reduce the interface impedance of a battery, and improve the safety and cycle performance of the battery.

Further, in partial thickness, the mass ratio of the lithium-containing material in the negative electrode coating layer varies with the coating layer thickness in the range of (1-5 wt %)/μm. For example, the variation gradient is 1 wt %/μm, 2 wt %/μm, 3 wt %/μm, 4 wt %/μm, 5 wt %/μm, etc. The variation gradient of the mass ratio of the lithium-containing material in the negative electrode coating layer with the coating layer thickness within the range of the present disclosure can effectively inhibit the growth of lithium dendrites and reduce the risk of a short circuit, thereby further improving the safety of the battery. In addition, migration paths of lithium ions can also be improved, disordered diffusion of lithium ions at an interface can be reduced, interface impedance can be reduced, and the rate performance and charging and discharging efficiency of a battery can be further improved.

Further, in a direction away from the substrate along the composite negative electrode, the content of the second material gradually increases. The gradual increase in the content of the second material can improve the electrical conductivity and mechanical strength of the material, thereby further enhancing the stability of the battery under high rate charging and discharging conditions.

Further, the thickness of the negative electrode coating layer is d, and in the range of 2% d-25% d from the substrate, the mass of the lithium-containing material is 50%-70% of the total mass of the lithium-containing material in the negative electrode coating layer; in the range of 25% d-40% d from the substrate, the mass of the lithium-containing material is 20%-40% of the total mass of the lithium-containing material in the negative electrode coating layer; and in the range of 40%-90% d from the substrate, the mass of the lithium-containing material is 10%-20% of the total mass of the lithium-containing material in the negative electrode coating layer.

Preferably, the thickness of the negative electrode coating layer is at most 50 μm, and in the range of 1 μm-12 μm from the substrate, the mass of the lithium-containing material is 50%-70% of the total mass of the lithium-containing material in the negative electrode coating layer; in the range of 12-20 μm from the substrate, the mass of the lithium-containing material is 20%-40% of the total mass of the lithium-containing material in the negative electrode coating layer, and in the range of 20-45 μm from the substrate, the mass of the lithium-containing material is 10%-20% of the total mass of the lithium-containing material in the negative electrode coating layer.

Another embodiment of the present application provides a lithium metal battery. The lithium metal battery comprises a positive electrode, an electrolyte, and a composite negative electrode prepared by the described method or the composite negative electrode of the present disclosure.

The present disclosure will be further described in detail with reference to the following examples, which should not be construed as limiting the scope of protection of the present disclosure.

In the following examples, the lithium content in the negative electrode coating layer was determined by XRF (i.e. X-ray fluorimeter). Specifically, a prepared negative electrode sheet was taken and cut along the thickness direction of the electrode sheet to obtain to-be-measured slices of regions having different thicknesses of the negative electrode sheet, the surface was flattened by tabletting, and the to-be-measured slices had a size of 40-50 mm and a thickness of 30-40 μm, wherein, a standard sample was a lithium-silicon alloy slice having a lithium content of 50%, and the lithium content of the to-be-measured slices was analyzed quantitatively by measuring the energy and strength of XRF.

### Example 1

Step S1: Lithium coated on a PET (polyethylene terephthalate) film was provided on a copper foil, and the PET film was removed to form a lithium layer, wherein the thickness of the lithium layer was 5 μm;

Step S2: Micro monocrystalline silicon and single-walled carbon nanotubes were ground by a ball mill for 30 min until the average particle size (D50) of the micro silicon reached about 1 μm, an appropriate amount of graphite was added and the mixture was poured into a homogenization tank equipped with a rotor, and polyacrylic acid (PAA) and deionized water were sequentially added into the homogenization tank. Then, the homogenization tank was placed in a homogenizer for homogenization, wherein the rotational speed of the homogenization tank in the homogenizer was 1000 r/min, the homogenization time was 3 min/time, and the number of homogenization was 5. Thereby, a homogeneously mixed silicon-carbon material was obtained. In the silicon-carbon material, the mass ratio of the micro silicon to the graphite was 0.1, the mass ratio of the micro silicon to the carbon nanotubes was 0.5, and the mass ratio of the second material (i.e. a mixture of the micro silicon, the graphite, and the carbon nanotubes) to PAA was 1.5.

The uniformly mixed silicon-carbon material was coated on the lithium layer, and dried to form a silicon-carbon layer, wherein the thickness of the silicon-carbon layer was 10 μm.

The silicon-carbon layer and the lithium layer were subjected to hot pressing on one side of the silicon-carbon layer, and the pressure during the application of the hot pressing was controlled to be 10 MPa, the temperature was controlled to be 60° C., and the duration was controlled to be 30 min, so as to obtain a composite electrode having a concentration gradient in the thickness direction.

### Example 2

Step S1: Lithium coated on a PET film was provided on a copper foil, and the PET film was removed to form a lithium layer, wherein the thickness of the lithium layer was 30 μm;

Step S2: Micro monocrystalline silicon and single-walled carbon nanotubes were ground by a ball mill for 5 min until the average particle size (D50) of the micro silicon reached about 40 μm, an appropriate amount of graphite was added and the mixture was poured into a homogenization tank equipped with a rotor, and carboxymethyl cellulose (CMC) and deionized water were sequentially added into the homogenization tank. Then, the homogenization tank was placed in a homogenizer for homogenization, wherein the rotational speed of the homogenization tank in the homogenizer was 1000 r/min, the homogenization time was 3 min/time, and the number of homogenization was 5. Thereby, a homogeneously mixed silicon-carbon material was obtained. In the silicon-carbon material, the mass ratio of the micro silicon to the graphite was 1, the mass ratio of the micro silicon to the carbon nanotubes was 2, and the mass ratio of the second material to CMC was 5.

The uniformly mixed silicon-carbon material was coated on the lithium layer, and dried to form a silicon-carbon layer, wherein the thickness of the silicon-carbon layer was 60 μm.

The silicon-carbon layer and the lithium layer were subjected to hot pressing on one side of the silicon-carbon layer, and the pressure during the application of the hot pressing was controlled to be 20 MPa, the temperature was controlled to be 100° C., and the duration was controlled to be 10 min, so as to obtain a composite electrode having a concentration gradient in the thickness direction.

### Example 3

Step S1: Lithium coated on a PET film was provided on a copper foil, and the PET film was removed to form a lithium layer, wherein the thickness of the lithium layer was 20 μm;

Step S2: Micro monocrystalline silicon and single-walled carbon nanotubes were ground by a ball mill for 15 min until the average particle size (D50) of the micro silicon reached about 20 μm, an appropriate amount of graphite was added and the mixture was poured into a homogenization tank equipped with a rotor, and polyacrylic acid (PAA) and deionized water were sequentially added into the homogenization tank. Then, the homogenization tank was placed in a homogenizer for homogenization, wherein the rotational speed of the homogenization tank in the homogenizer was 1000 r/min, the homogenization time was 3 min/time, and the number of homogenization was 5. Thereby, a homogeneously mixed silicon-carbon material was obtained. In the silicon-carbon material, the mass ratio of the micro silicon to the graphite was 3, the mass ratio of the micro silicon to the carbon nanotubes was 8, and the mass ratio of the second material to PAA was 10.

The uniformly mixed silicon-carbon material was coated on the lithium layer, and dried to form a silicon-carbon layer, wherein the thickness of the silicon-carbon layer was 40 μm.

The silicon-carbon layer and the lithium layer were subjected to hot pressing on one side of the silicon-carbon layer, and the pressure during the application of the hot pressing was controlled to be 40 MPa, the temperature was controlled to be 80° C., and the duration was controlled to be 15 min, so as to obtain a composite electrode having a concentration gradient in the thickness direction.

### Example 4

Step S1: Lithium coated on a PET film was provided on a copper foil, and the PET film was removed to form a lithium layer, wherein the thickness of the lithium layer was 15 μm;

Step S2: Micro monocrystalline silicon and single-walled carbon nanotubes were ground by a ball mill for 20 min until the average particle size (D50) of the micro silicon reached about 15 μm, an appropriate amount of graphite was added and the mixture was poured into a homogenization tank equipped with a rotor, and polyvinylidene fluoride (PVDF) and deionized water were sequentially added into the homogenization tank. Then, the homogenization tank was placed in a homogenizer for homogenization, wherein the rotational speed of the homogenization tank in the homogenizer was 1000 r/min, the homogenization time was 3 min/time, and the number of homogenization was 5. Thereby, a homogeneously mixed silicon-carbon material was obtained. In the silicon-carbon material, the mass ratio of the micro silicon to the graphite was 4, the mass ratio of the micro silicon to the carbon nanotubes was 15, and the mass ratio of the second material to PVDF was 20.

The uniformly mixed silicon-carbon material was coated on the lithium layer, and dried to form a silicon-carbon layer, wherein the thickness of the silicon-carbon layer was 30 μm.

The silicon-carbon layer and the lithium layer were subjected to hot pressing on one side of the silicon-carbon layer, and the pressure during the application of the hot pressing was controlled to be 30 MPa, the temperature was controlled to be 85° C., and the duration was controlled to be 10 min, so as to obtain a composite electrode having a concentration gradient in the thickness direction.

### Example 5

Step S1: Lithium coated on a PET film was provided on a copper foil, and the PET film was removed to form a lithium layer, wherein the thickness of the lithium layer was 10 μm;

Step S2: Micro monocrystalline silicon and single-walled carbon nanotubes were ground by a ball mill for 15 min until the average particle size (D50) of the micro silicon reached about 20 μm, an appropriate amount of graphite was added and the mixture was poured into a homogenization tank equipped with a rotor, and styrene-butadiene rubber (SBR) and deionized water were sequentially added into the homogenization tank. Then, the homogenization tank was placed in a homogenizer for homogenization, wherein the rotational speed of the homogenization tank in the homogenizer was 1000 r/min, the homogenization time was 3 min/time, and the number of homogenization was 5. Thereby, a homogeneously mixed silicon-carbon material was obtained. In the silicon-carbon material, the mass ratio of the micro silicon to the graphite was 5, the mass ratio of the micro silicon to the carbon nanotubes was 20, and the mass ratio of the second material to SBR was 55.

The uniformly mixed silicon-carbon material was coated on the lithium layer, and dried to form a silicon-carbon layer, wherein the thickness of the silicon-carbon layer was 40 μm.

The silicon-carbon layer and the lithium layer were subjected to hot pressing on one side of the silicon-carbon layer, and the pressure during the application of the hot pressing was controlled to be 40 MPa, the temperature was controlled to be 70° C., and the duration was controlled to be 20 min, so as to obtain a composite electrode having a concentration gradient in the thickness direction.

### Example 6

A composite electrode was prepared in the same manner as that in Example 1, except that the hot pressing process of step S2 was not applied to the lithium layer and the silicon-carbon layer.

### Example 7

A composite electrode was prepared in the same manner as that in Example 1, except that in step S2, the mass ratio of the micron silicon to the graphite was 0.05, the mass ratio of the micron silicon to the carbon nanotubes was 0.1, and the mass ratio of the second material to PAA was 1.

### Example 8

A composite electrode was prepared in the same manner as that in Example 1, except that in step S2, the mass ratio of the micro silicon to the graphite was 8, the mass ratio of the micro silicon to the carbon nanotubes was 25, and the mass ratio of the second material to PAA was 60.

### Example 9

A composite electrode was prepared in the same manner as that in Example 1, except that in step S2, when applying hot pressing, the pressure was controlled to be 5 MPa, the temperature was controlled to be 50° C., and the duration was controlled to be 10 min.

### Example 10

A composite electrode was prepared in the same manner as that in Example 1, except that in step S2, when applying hot pressing, the pressure was controlled to be 5 Mpa, the temperature was controlled to be 80° C., and the duration was controlled to be 10 min.

### Example 11

A composite electrode was prepared in the same manner as that in Example 1, except that in step S2, when applying hot pressing, the pressure was controlled to be 30 Mpa, the temperature was controlled to be room temperature, and the duration was controlled to be 15 min.

### Example 12

A composite electrode was prepared in the same manner as that in Example 1, except that in step S2, when applying hot pressing, the pressure was controlled to be 45 Mpa, the temperature was controlled to be 110° C., and the duration was controlled to be 18 min.

### Performance Tests

### I. Preparation of a Battery

Preparation of a button battery: A ternary positive electrode material was coated on the surface of a carbon-coated aluminium foil with the thickness of the coating layer being 30 μm, and then prepared into a positive electrode button electrode sheet having a diameter d of 16 mm, and an electrolyte membrane having a diameter d of 18 mm and a negative electrode button electrode sheet having a diameter d of 19 mm were used. Then, the positive electrode and the electrolyte membrane were first subjected to hydraulic pressing at 50 MPa for 15 min and hot pressing at 50 T for 30 min. Then, a silicon-carbon composite negative electrode was bonded and subjected to a process comprising hydraulic pressing at 50 MPa for 15 min and hot pressing at 50 T for 30 min to prepare a button battery, wherein the battery is 2016 model. The following performance tests were all conducted under conditions of 55° C.

The composite negative electrode sheet obtained by the process according to any one of Examples 1 to 12 was used as the described button electrode sheet.

### II. Performance Tests

### (1) Cycle Performance Test

The batteries were charged and discharged at a constant current of 0.1 C for the first two cycles to activate the batteries, and then the cycle performance was tested at a current of 0.33 C. When the specific capacity of the curve fluctuated greatly and the battery capacity retention ratio was lower than 80%, it indicated that the batteries had failed.

### (2) Rate Performance Test

The batteries were charged and discharged twice at a current of 0.05 C to activate the batteries, and then the batteries prepared in the examples were tested for rate performance with currents of 0.5 C and 1 C, respectively.

The batteries were charged and discharged at different rates. If the batteries were cycled at least 80 times and the capacity retention ratio was still greater than or equal to 80%, they were considered as valid batteries. If the capacity retention ratio of the batteries was lower than 80%, the batteries were considered to be failed.

### (3) First Coulombic Efficiency Test

The prepared all-solid button cell was charged to 4.25 V at a constant current of 0.1 C, and then discharged to 2.5 V at a constant current of 0.1 C, and the first coulombic efficiency was obtained by calculating the ratio of the first discharge capacity to the first charge capacity.

The performance test results of the described examples are shown in Table 1.

TABLE 1

| | | First | Rate performance | | |
|---|---|---|---|---|---|
| | Number of | columbic | | | Capacity |
| | cycles | efficiency | | Number of | retention |
| No. | (0.33 C) | (0.1 C) | Rate | cycles | ratio |
| Example 1 | 95 | 80% | 0.5 C | 50 | 81% |
| | | | 1 C | 30 | 81% |
| Example 2 | 98 | 82% | 0.5 C | 80 | 83% |
| | | | 1 C | 50 | 79% |
| Example 3 | 100 | 88% | 0.5 C | 90 | 85% |
| | | | 1 C | 85 | 87% |
| Example 4 | 89 | 79% | 0.5 C | 70 | 84% |
| | | | 1 C | 45 | 79% |
| Example 5 | 96 | 76% | 0.5 C | 30 | 80% |
| | | | 1 C | 25 | 82% |
| Example 6 | 50 | 70% | 0.5 C | 45 | 73% |
| | | | 1 C | 25 | 63% |
| Example 7 | 60 | 65% | 0.5 C | 50 | 70% |
| | | | 1 C | 35 | 68% |
| Example 8 | 45 | 67% | 0.5 C | 40 | 76% |
| | | | 1 C | 30 | 68% |
| Example 9 | 60 | 68% | 0.5 C | 40 | 75% |
| | | | 1 C | 30 | 68% |
| Example | 75 | 62% | 0.5 C | 25 | 77% |
| 10 | | | 1 C | 20 | 68% |
| Example | 51 | 60% | 0.5 C | 25 | 71% |
| 11 | | | 1 C | 18 | 65% |
| Example | 66 | 68% | 0.5 C | 25 | 69% |
| 12 | | | 1 C | 20 | 65% |

The data of the number of cycles (0.33 C) shown in Table 1 shows the number of charging and discharging cycles when the capacity retention ratio of the battery is 80% and the battery was subjected to charging and discharging cycle test at a current of 0.33 C.

From the description above, it can be determined that the battery made by the composite electrode prepared by the method of the present invention has excellent cell cycle performance, first coulomb efficiency and rate performance.

It should be noted that terms such as “first” and “second” in the description and claims of the present application are used to distinguish similar objects, and are not necessarily used to describe a specific sequence or order. It should be understood that the terms so used are interchangeable under appropriate circumstances such that the embodiments of the present application described herein can, for example, be practiced in sequences other than those described herein.

The description above is only the preferred examples of the present invention, and is not intended to limit the present invention. For a person skilled in the art, the present invention may have various modifications and variations. Any modifications, equivalent replacements, improvements and the like made within the spirit and principle of the present invention shall fall within the scope of protection of the present invention.

1. A method for preparing a composite negative electrode, wherein the method comprises the following steps:
step S1, providing a first material on a first substrate to form a first material layer; and
step S2, providing a second material on a second substrate to form a second material layer, bonding the second material layer to the first material layer, performing hot pressing on the first material layer and the second material layer, and then removing the second substrate to obtain a composite negative electrode, wherein at least part of the composite negative electrode has a concentration gradient in the thickness direction, or
directly providing the second material on the first material layer to form the second material layer, and performing hot pressing on the first material layer and the second material layer to obtain a composite negative electrode, wherein at least part of the composite negative electrode has a concentration gradient in the thickness direction thereof.

2. The method of claim 1, wherein in step S1, the first material comprises a lithium-containing material, and
the first substrate is selected from a copper foil and a composite copper foil.

3. The method of claim 1, wherein in step S2, the second material comprises a carbon material and/or a silicon material, and
the second substrate is selected from a copper foil and a composite copper foil.

4. The method of claim 3, wherein the carbon material comprises one or more of natural graphite, synthetic graphite, soft carbon, hard carbon, carbon black, ketjen carbon, acetylene black, Super P, graphene, and single wall carbon nanotubes, and
the silicon material comprises one or more of monocrystalline silicon, polycrystalline silicon, and amorphous silicon.

5. The method of claim 1, wherein the first material layer has a thickness in the range of 5 μm to 30 μm, and/or the second material layer has a thickness in the range of 10 μm to 60 μm.

6. The method of claim 1, wherein in step S2, the average particle diameter (D50) of the second material is in the range of 1 μm to 40 μm.

7. The method of claim 1, wherein in step S2, the second material layer further comprises an adhesive, and the adhesive comprises one or more of polyacrylic acid (PAA), styrene-butadiene rubber (SBR), polyvinylidene fluoride (PVDF), and carboxymethyl cellulose (CMC).

8. The method of claim 1, wherein in step S2, the second material layer further comprises a conductive agent, and the conductive agent comprises a vapor grown carbon fiber (VGCF).

9. The method of claim 1, wherein the second material comprises silicon, graphite, and carbon nanotubes, the mass ratio of the silicon to the graphite is 0.1-5.0, and the mass ratio of the silicon to the carbon nanotubes is 0.5-20.0.

10. The method of claim 1, wherein the ratio of a thickness H₁ of the second material layer to a thickness H₂ of the first material layer satisfies 1<H₁/H₂≤10.

11. The method of claim 1, wherein the ratio of an area S₁ of the second material layer to an area S₂ of the first material layer satisfies 1.0<S₁/S₂≤1.5.

12. The method of claim 1, wherein in step S2, the hot pressing is performed at a pressure of 10 MPa to 40 MPa at a temperature of 60° C. to 100° C.

13. The method of claim 1, wherein in step S2, the duration of the hot pressing lasts for 5 min to 30 min.

14. The method of claim 1, wherein,
in step S1, a copper-lithium composite current collector is used as a composite of the first substrate and the first material layer, and
in step S2, the second material is provided directly on a lithium layer of the composite to form the second material layer.

15. The method of claim 1, wherein in step S2, the concentration gradient is a concentration gradient of the first material; or a concentration gradient of both the first material and the second material.

16. A composite negative electrode prepared by the method of claim 1, wherein the composite negative electrode comprises a substrate and an negative electrode coating layer provided on the substrate, the negative electrode coating layer comprises a lithium-containing material and a second material, the negative electrode coating layer has a concentration gradient of the lithium-containing material in the thickness direction, and the content of the lithium-containing material gradually decreases in partial thickness in a direction away from the substrate along the composite negative electrode.

17. The composite negative electrode of claim 16, wherein in partial thickness, the mass ratio of the lithium-containing material in the negative electrode coating layer varies with the coating layer thickness in the range of (1-5 wt %)/μm.

18. The composite negative electrode of claim 16, wherein the content of the second material gradually increases in a direction away from the substrate along the composite negative electrode.

19. The composite negative electrode of claim 16, wherein the thickness of the negative electrode coating layer is d, in the range of 2% d-25% d from the substrate, the mass of the lithium-containing material is 50%-70% of the total mass of the lithium-containing material in the negative electrode coating layer; in the range of 25% d-40% d from the substrate, the mass of the lithium-containing material is 20%-40% of the total mass of the lithium-containing material in the negative electrode coating layer; and in the range of 40%-90% d from the substrate, the mass of the lithium-containing material is 10%-20% of the total mass of the lithium-containing material in the negative electrode coating layer.

20. A lithium metal battery, wherein the lithium metal battery comprises:
a positive electrode,
an electrolyte, and
a composite negative electrode prepared by the method of claim 1.
